(19) United States
(12) Patent Application Publication
(10) Pub. No.: US 2022/0369677 A1
(43) Pub. Date: Nov. 24, 2022

(54) Cereal Compositions Containing Human Milk Oligosaccharides

(71) Applicant: Chr. Hansen HMO GmbH, Rheinbreitbach (DE)

(72) Inventor: Stefan Jennewein, Bad Honnef (DE)

(73) Assignee: Chr. Hansen HMO GmbH, Rheinbreitbach (DE)

(21) Appl. No.: 17/761,249

(22) PCT Filed: Sep. 19, 2019
(86) PCT No.: PCT/EP2019/075138

§ 371 Date: Mar. 17, 2022

(30) Foreign Application Priority Data
Sep. 18, 2019 (ES) U201931515

(51) Int. Cl. A23L 7/117; A23L 19/00; A23L 33/15; A23L 33/00; A23L 33/125

(52) U.S. Cl. CPC A23L 7/117; A23L 19/01; A23L 33/15; A23L 33/40; A23L 33/125

(57) ABSTRACT

Disclosed is a cereal composition which can be prepared instantly with the addition of a liquid, containing at least one human milk oligosaccharide (HMO), and other components which are necessary for the healthy growth and development of a young 5 individual.

### FIELD OF THE INVENTION

The present invention relates to cereal compositions. More particularly, the present invention relates to cereal compositions which can be prepared instantly with the addition of a liquid.

### BACKGROUND

A good nutrition during the early months of an infant is essential for their optimal development, growth and good health. After a child reaches 2 years of age, it is very difficult to reverse stunting that has occurred earlier (Martorell et al., 1994). In this respect, studies have shown that this is the peak age for growth faltering, deficiencies of certain micronutrients, and common childhood illnesses such as diarrhea.

The World Health Organization (WHO) says that, as a global public health recommendation, during the first 6 months of life of an infant, the infant should be fed with human breast milk, which can protect it from infections and other diseases besides giving it the necessary nutrition for their healthy growth and development.

Thereafter, after 6 months and in order to meet their evolving nutritional requirements, infants should receive nutritionally adequate and safe complementary foods while breastfeeding continues for up to two years of age or beyond. Around the age of 6 months, an infant's need for energy and nutrients starts to exceed what is provided by breast milk, and complementary foods are necessary to meet those needs. An infant of this age is also developmentally ready for other foods. If complementary foods are not introduced around the age of 6 months, or if they are given inappropriately, an infant's growth may falter.

Among the complementary foods are those which can be instantly prepared with only the addition of a liquid, which can be water, milk and/or juice. Included in these instantly prepared foods are those that contain cereals. Since this is the first time a young individual is experiencing the taste and texture of solid food, it is important that this instantly prepared food contain ingredients that are well tolerated and digested and at the same time bring nutrition to the young individual.

Cereals are well known for being an excellent source of energy, and infants need to increase their energy intake to meet their evolving nutritional requirements, especially since breastfeeding is reduced or if breastfeeding is no longer available. Cereals also contain a considerable amount of carbohydrates and proteins, as well as being a good source of vitamins and minerals. In this regard, cereals are also a good source for iron fortification. Infants and toddlers who consume infant cereal have higher iron intakes compared to non-users (Finn, et. al., 2017). Cereals provide non-digestible carbohydrates, which are mainly responsible for the development of an ‘adult-like’ microbiota by increasing the Bacteroides population. During weaning, clear changes in the infant's gut microbiota have been observed upon the addition of either wheat, sorghum, rice, or oats into a large intestine in vitro, and a higher proportion of complex carbohydrates in infant cereals has been shown to lead to a higher fermentative activity of the intestinal microbiota of infants aged six to 10 months in vivo (Klerks, et. al., Nutrients. 2019 February; 11(2): 473 Infant Cereals: Current Status, Challenges, and Future Opportunities for Whole Grains).

Human breast milk contains substantial amounts of carbohydrates. The carbohydrates that are present in human breast milk include monosaccharides such as L-fucose and N-acetylneuraminic acid, the disaccharide lactose, and up to 20 g/I oligosaccharides, the so-called “human milk oligosaccharides (HMOs)”. HMOs represent the third most abundant constituent of human breast milk. It is presumed that more than 150 structurally distinct oligosaccharides are present in human milk. Selected HMOs are shown in Table 1. Each of about 10 to 13 of these HMOs are present in human milk in a concentration of between several hundred milligrams to grams per liter (Thurl et al. (2017), Nutrition Reviews 75(11) 920-933). Among the HMOs, neutral HMOs are known as well as acidic HMOs which contain at least one N-acetylneuraminic acid (NeuAc) moiety. The structural complexity and abundance of these oligosaccharides is unique for human milk and has not been found in the milk of other mammals such as—for example—domesticated dairy animals.

The existence of these complex oligosaccharides in human milk is known already for a long time and the physiological functions of these oligosaccharides were subject to medicinal research for many decades (Gura, T. (2014) Nature's first functional food. Science 345(6198) 747-749). For some of the more abundant human milk oligosaccharides, specific functions have already been identified (Bode, L. (2012) Human milk oligosaccharides: every baby needs a sugar mama. Glycobiology 22(9), 1147-1162; Bode L, Jantscher-Krenn E (2012) Structure-function relationships of human milk oligosaccharides. Adv Nutr 3(3) 383S-391S; Morrow A L, Ruiz-Palacios G M, Altaye M, Jiang X, Guerrero M L, Meinzen-Derr J K, Farkas T, Chaturvedi P, Pickering L K, Newburg D S (2004) Human milk oligosaccharides are associated with protection against diarrhea in breast-fed infants. J Pediatr 145(3) 297-303).

Since HMOs are not digested by humans, the physiological role of these saccharides has been under investigation for several decades. The prebiotic effect of HMOs was discovered more than 100 years ago. Upon consumption, HMOs are able to modulate the composition of the human gut microbiome by supporting growth of beneficial bacteria.

TABLE 1
Structures of notable oligosaccharides in human breast milk.

| Name | Chemical structure | |
|---|---|---|
| 2′-FL | Fuc(α1,2)Gal (β1,4)Glc | |
| 3-FL | Gal(β1,4) (Fuc(α1,3))Glc | |
| DFL | Fuc(α1,2)Gal(β1,4)Glc | |
| | (α1,2)\| | |
| | Fuc | |
| LNT | Gal(β1,3)GlcNAc(β1,3)Gal(β1,4)Glc | |
| LNnT | Gal(β1,4)GlcNAc(β1,3)Gal(β1,4)Glc | |
| LNFP-I | Fuc(α1,2)Gal(β1,3)GlcNAc(β1,3)Gal(β1,4)Glc | |
| LNFP-II | Gal(β1,3) (Fuc(α1,4))GlcNAc(β1,3)Gal(β1,4)Glc | |
| LNFP-III | Gal(β1,4) (Fuc(α1,3))GlcNAc(β1,3)Gal(β1,4)Glc | |
| LNFP-V | Gal(β1,3) GlcNAc(β1,3)Gal(β1,4) (Fuc(α1,3))Glc | |
| 3′-SL | NeuAc(α2,3)Gal(31, 4)Glc | |
| 6′-SL | NeuAc(α2,6)Gal(31,4)Glc | |
| LSTa | NeuAc(α2,3)Gal(β1,3)GlcNAc(β1,3)Gal(β1,4)Glc | |
| LSTb | NeuAc | |
| | \| (α2,6) | |
| | Gal(β1,3) GlcNAc (β1,3) Gal (β1,4) Glc | |
| LSTc | NeuAc (α2, 6) Gal (β1,4) GlcNAc (β1,3) Gal (β1,4) Glc | |
| LNDFH-I | Fuc(α1,2)Gal(β1,3)GlcNAc(β1,3)Gal(β1,4)Glc | |
| | \| (α1,4) | |
| | Fuc | |
| LNDFH-II | Gal(β1,3)GlcNAc(β1,3)Gal(β1, 4)Glc | |
| | \| (α1,4) | (α1,3) \| |
| | Fuc | Fuc |
| LNDFH-III | Gal(β1,3)GlcNAc(β1,3)Gal(β1,4)Glc | |
| | \| (α1,3) | (α1,3) \| |
| | Fuc | Fuc |

| | |
|---|---|
| F-LSTa | NeuAc(α2,3)Gal(β1,3)GlcNAc(β1,3)Gal(β1,4)Glc |
| | \| (α1,4) |
| | Fuc |
| F-LSTb | NeuAc |
| | \| (α2,6) |
| | Fuc(α1,2)Gal(β1,3)GlcNAc(β1,3)Gal(β1,4)Glc |
| F-LSTc | NeuAc(α2,6)Gal(β1,4)GlcNAc(β1,3)Gal(β1,4)Glc |
| | (α1,3) \| |
| | Fuc |
| FSL | NeuAc(α2,3)Gal(β1,4)Glc |
| | (α1,3) \| |
| | Fuc |
| DS-LNT | NeuAc |
| | \| (α2,6) |
| | NeuAc(α2,3)Gal(β1,3)GlcNAc(β1,3)Gal(β1,4)Glc |
| FDS-LNT-I | NeuAc |
| | \| (α2,6) |
| | NeuAc(α2,3)Gal(β1,4)GlcNAc(β1,3)Gal(β1,4)Glc |
| FDS-LNT-II | NeuAc |
| | \| (α2,6) |
| | NeuAc(α2,3)Gal(β1,4)GlcNAc(β1,3)Gal(β1,4)Glc |
| | (α1,3) \| |
| | Fuc |

Several other functional effects of HMOs were revealed in the last years, especially their effect on the development of neonates. HMOs are known to act as decoys to reduce the risk of infections by bacterial and viral pathogens which adhere to human cells by binding to these cells' surface glycoproteins. Additionally, various HMOs possess an anti-inflammatory effect and act as immunomodulators. Hence, it was proposed that HMOs reduce the risks of developing food allergies. A positive effect of sialylated HMOs on the development of a neonate's central nervous system is also intensely discussed (reviewed in “Prebiotics and Probiotics in Human Milk, Origins and functions of milk-borne oligosaccharides and bacteria”, Academic Press (2017) editors: McGuire M., McGuire M., and Bode L.).

To take advantage of the beneficial effects of HMOs, efforts are made in adding individual HMOs to nutritional compositions, in particular to infant formula. However, supplementing nutritional compositions with a combination of different HMOs would be better, because such compositions more closely resemble the natural source of HMOs, i.e. human milk, and are more likely to possess better effects on a person's health and development than compositions containing only a single species of the HMOs.

Considering the beneficial effects that HMOs have and in order to continue with the supplementation of HMOs to young individuals after about 4 months of age, there has been found that there is a need in the food industry, for cereal compositions containing one or more human milk oligosaccharides, and especially for dried cereal compositions containing one or more human milk oligosaccharides which can be instantly prepared by the addition of a liquid.

### SUMMARY

The present invention concerns a cereal composition containing one or more human milk oligosaccharides (HMOs) and other components, which are necessary for the healthy growth and development of a young individual.

More particularly, the present invention relates to a novel cereal composition containing one or more cereals, and one or more human milk oligosaccharides, as well as other components, which can be prepared instantly with the addition of a liquid.

Furthermore, it is an object of the present invention to provide a cereal composition for young individuals, said cereal composition comprising at least 0.05 wt. % of one or more human milk oligosaccharides based on dry weight of the cereal composition.

Another object of the present invention is to provide a cereal composition containing at least five structurally distinct human milk oligosaccharides.

It is a further object of the present invention to provide a cereal composition containing at least seven structurally distinct human milk oligosaccharides.

It is yet another object of the present invention to provide a cereal composition containing at least seven structurally distinct human milk oligosaccharides, and at least one monosaccharide selected from the group consisting of sialic acid and L-fucose.

### DETAILED DESCRIPTION

According to the present invention, it is provided a cereal composition containing one or more human milk oligosaccharides (HMOs) and other components, which are necessary for the healthy growth and development of a young individual, and which can be prepared instantly with the addition of a liquid.

As used herein, “young individual” refers to an infant, toddler, or child. Unless the terms “infant,” “toddler,” or “child” are used separately, then all three are assumed, and contained within the term “young individual”. The term “infant”, as used herein, refers to an individual in the age of about 4 to 12 months. The term “toddler”, as used herein, refers to an individual in the age of about 1 to 3 years old. The term “child”, as used herein, refers to an individual in the age of about 3 to 11 years old.

It is well known in the prior art that cereal compositions for young individuals need to be adjusted according to the nutritional requirements of their age. The caloric content, the proteins, carbohydrates and lipids must be adjusted to the needs of the young individuals depending on their stage of development and their age.

To comply with the nutrition needed by a young individual at their different stages of development and age, the present invention provides an adjustable cereal composition for instant preparation with the addition of a liquid. Such cereal composition comprises one or more of the following components:
from 10 to 90 wt. % of a cereal component based on dry weight of the cereal composition,
from 1 to 40 wt. % of fibre based on dry weight of the cereal composition,
from 4 to 30 wt. % of protein based on dry weight of the cereal composition,
from 1 to 10 wt. % of fat based on dry weight of the cereal composition,
from 2 to 15 wt. % of dried fruits or vegetables based on dry weight of the cereal composition,
from 1 to 10 wt. % micronutrients based on dry weight of the cereal composition,
from 0.5 to 10 wt. % of additives based on dry weight of the cereal composition.

The composition further comprises a maximum of 15 wt. %, based on dry weight of the cereal composition, of at least one human milk oligosaccharide or a mixture of human milk oligosaccharides.

In an embodiment of the present invention, the cereal composition further comprises at least 0.01 wt. %, 0.02 wt. %, 0.03 wt %, 0.04 wt %, 0.05%, based on dry weight of the cereal composition, of one or more human milk oligosaccharides.

In another embodiment of the present invention, the cereal composition comprises a maximum of 11 wt. %, 12 wt. %, 13 wt. %, 14 wt. %, 15 wt. % of one or more human milk oligosaccharides based on dry weight of the cereal composition.

In an embodiment of the present invention, the cereal composition may further comprise from 10 to 50 wt. %, based on dry weight of the cereal composition, of a milk component. Such milk component is preferably selected from one or more of the group consisting of whey powder, skimmed milk powder, whole milk powder and yoghurt powder.

The cereal composition of the present invention may be present in a form selected from the group consisting of a powder, granules, flakes, pellets and mixtures of at least two of said forms. Usually, the cereal compositions prepared according to the present invention have to be mixed with a liquid, until the desired consistency is obtained, before consumption by the young individual. The liquid used for the instant preparation of the cereal composition according to the present invention is preferably selected from the group consisting of water, milk and juice.

The cereal component of the present invention is preferably in the form selected from the group consisting of cereal flour, crushed cereal, pulverized cereal, grinned cereal and mixtures of at least two of said forms. The cereal component is preferably selected from one or more of the group consisting of barley, oats, wheat, rice, rye, millet, sorghum and corn.

The fruits and vegetables contained in the cereal composition of the present invention, are dried fruits and vegetables that may be present in the form of a powder or flakes. Such dried fruits are preferably selected from one or more of the group consisting of banana, raspberry, blueberry, blackcurrant, peach, apricot, apple and pear. The dried vegetables of the present cereal composition are preferably selected from one or more of the group consisting of potato, tomato and leafy green vegetables.

The cereal composition according to the present invention contain micronutrients, which help reduce anaemia rates in young individuals. The micronutrients of the present invention are preferably selected from one or more of the group consisting of iron, zinc, selenium, calcium, and vitamins.

The additives comprised in the cereal composition of the present invention are preferably selected from one or more of the group consisting of fructo-oligosaccharides (FOS), galacto-oligosaccharides (GOS), maltodextrin, colorants and sweeteners.

The cereal composition of the present invention further contains oligosaccharides, specifically human milk oligosaccharides (HMOs). Human milk oligosaccharides have shown to influence the development of the intestinal microbiome and thus have a positive impact on infant health. Studies also have shown that they protect neonates from viral and bacterial infections, reduce the risk of allergies and inflammation, and promote brain development and neuronal activity. Considering all these positive effects in young individuals and the need for a cereal composition containing a cereal component for instant preparation, one or more HMOs have been included in the present cereal composition.

The at least one or more HMOs of the present cereal composition may be produced by microbial fermentation, wherein a genetically-engineered microorganism that is able to synthesize an HMO is cultivated in a culture medium (fermentation broth) and under conditions that are permissive for the synthesis of said HMO by said genetically-engineered microorganism. The said at least one human milk oligosaccharide is selected preferably from the group consisting of acetyl-N-lactosamine, sialylated oligosaccharide, and fucosylated oligosaccharides.

The at least one or more acetyl-N-lactosamine is preferably selected from one or more of the group consisting of lacto-N-tetraose (LNT), lacto-N-neotetraose (LNnT) and lacto-N-fucopentaose I (LNPFI).

The at least one or more sialylated oligosaccharide is preferably selected from one or more of the group consisting of 3′-sialyllactose (3′-SL), 6′-sialyllactose (6′-SL), sialyllacto-N-tetraose a (LST-a), sialyllacto-N-tetraose b (LST-b), sialyllacto-N-tetraose c (LST-c) and disialyllacto-N-tetraose (DSLNT).

The at least one or more fucosylated oligosaccharide is preferably selected from one or more of the group consisting of 2′-fucosyllactose (2′-FL) and 3-fucosyllactose (3-FL).

In an embodiment of the present invention, the cereal composition may contain a mixture of at least five structurally distinct human milk oligosaccharides. Such five structurally distinct human milk oligosaccharides are preferably selected from the group consisting of 2′-fucosyllactose (2′-FL), 3-fucosyllactose (3-FL), lacto-N-tetraose (LNT), 3′-sialyllactose (3′-SL) and 6′-sialyllactose (6′-SL). In an exemplary composition of the said mixture, the five structurally distinct HMOs are present in the mixture in amounts as specified in Table 2. It is understood that the amount of each component of the mixture as specified in Table 2 represents the average amount, and that the amount of each of the given components of the mixture may vary in the range of about ±10%, preferably of about ±5% with respect to the amounts specified in Table 2 for each component.

TABLE 2
Composition of an exemplary mixture consisting of five
structurally distinct HMOs.

| HMO | %-wt. |
|---|---|
| 2′-FL | 52.2 |
| 3-FL | 13.0 |
| LNT | 26.1 |
| 3′-SL | 3.5 |
| 6′-SL | 5.2 |
| Total | 100.0 |

In an additional and/or alternative embodiment of the present invention, the cereal composition may contain a mixture of at least seven structurally distinct human milk oligosaccharides. Such seven structurally distinct human milk oligosaccharides are preferably selected from the group consisting of 2′-fucosyllactose (2′-FL), 3-fucosyllactose (3-FL), lacto-N-tetraose (LNT), lacto-N-neotetraose (LNnT), lacto-N-fucopentaose I (LNFPI), 3′-sialyllactose (3′-SL) and 6′-sialyllactose (6′-SL). In an exemplary composition of the said mixture, the seven structurally distinct HMOs are present in the mixture in amounts as specified in Table 3. It is understood that the amount of each component of the mixture as specified in Table 3 represents the average amount, and that the amount of each of the given components of the mixture may vary in the range of about ±10%, preferably of about ±5% with respect to the amounts specified in Table 3 for each component.

TABLE 3
Composition of an exemplary mixture consisting of
seven structurally distinct HMOs

| HMO | %-wt. |
|---|---|
| 2′-FL | 39.0 |
| 3-FL | 12.0 |
| LNT | 23.0 |
| LNnT | 2.0 |
| LNFPI | 16.0 |
| 3′-SL | 3.0 |
| 6′-SL | 5.0 |
| Total | 100.0 |

In an additional and/or alternative embodiment of the present invention, the cereal composition may contain a mixture of at least seven structurally distinct human milk oligosaccharides, and at least one monosaccharide selected from the group consisting of sialic acid and L-fucose. Such seven structurally distinct human milk oligosaccharides are preferably selected from the group consisting of 2′-fucosyllactose (2′-FL), 3-fucosyllactose (3-FL), lacto-N-tetraose (LNT), lacto-N-neotetraose (LNnT), lacto-N-fucopentaose I (LNFPI), 3′-sialyllactose (3′-SL) and 6′-sialyllactose (6′-SL). In an exemplary composition of the said mixture, the seven structurally distinct HMOs and the two monosaccharides are present in the mixture in amounts as specified in Table 4. It is understood that the amount of each component of the mixture as specified in Table 4 represents the average amount, and that the amount of each of the given components of the mixture may vary in the range of about ±10%, preferably of about ±5% with respect to the amounts specified in Table 4 for each component.

TABLE 4
Composition of an exemplary mixture containing
HMOs and two monosaccharides.

| HMO | %-wt. |
|---|---|
| 2′-FL | 33.6 |
| 3-FL | 10.7 |
| LNT | 20.1 |
| LNnT | 2.0 |
| LNFPI | 13.4 |
| 3′-SL | 2.7 |
| 6′-SL | 4.0 |
| Sialic acid | 8.1 |
| L-fucose | 5.4 |
| Total | 100.0 |

In an additional and/or alternative embodiment of the present invention, the composition of the mix containing five structurally distinct HMOs, according to the second column in Table 5 is of particular advantage for supplementing the cereal composition of the present invention, such that the final cereal composition, prepared instantly with the addition of a liquid for direct consumption, may contain the compounds of the mixture in concentrations as specified in the third column of Table 5. It is understood that the amount of each component of the mixture as specified in Table 5 represents the average amount, and that the amount of each of the given components of the mixture may vary in the range of about ±10%, preferably of about ±5% with respect to the amounts specified in Table 5 for each component.

TABLE 5
Composition of a representative mixture containing five
structurally distinct HMOs suitable for cereal compositions.

| | | Final concentration in |
|---|---|---|
| | | cereal composition |
| HMO | %-wt. | (g/cm³) |
| 2′-FL | 52.2 | 0.3 |
| 3-FL | 13.0 | 0.075 |
| LNT | 26.1 | 0.15 |
| 3′-SL | 3.5 | 0.02 |
| 6′-SL | 5.2 | 0.03 |
| Total | 100.0 | 0.575 |

In an additional and/or alternative embodiment of the present invention, the composition of the mixture containing seven structurally distinct HMOs, according to the second column in Table 6 is of particular advantage for supplementing the cereal composition of the present invention, such that the final cereal composition, prepared instantly with the addition of a liquid for direct consumption, may contain the compounds of the mixture in concentrations as specified in the third column of Table 6. It is understood that the amount of each component of the mixture as specified in Table 6 represents the average amount, and that the amount of each of the given components of the mixture may vary in the range of about ±10%, preferably of about ±5% with respect to the amounts specified in Table 6 for each component.

TABLE 6
Composition of a representative mixture containing seven
structurally distinct HMOs suitable for cereal compositions.

| | | Final concentration in |
|---|---|---|
| | | cereal composition |
| HMO | %-wt. | (g/cm³) |
| 2′-FL | 39.0 | 0.25 |
| 3-FL | 12.0 | 0.08 |
| LNT | 23.0 | 0.15 |
| LNnT | 2.0 | 0.015 |
| LNFPI | 16.0 | 0.1 |
| 3′-SL | 3.0 | 0.2 |
| 6′-SL | 5.0 | 0.03 |
| Total | 100.0 | 0.645 |

In an additional and/or alternative embodiment of the present invention, the composition of the mixture containing seven structurally distinct HMOs and two monosaccharides, according to the second column in Table 7 is of particular advantage for supplementing the cereal composition of the present invention, such that the final cereal composition, prepared instantly with the addition of a liquid for direct consumption, may contain the compounds of the mixture in concentrations as specified in the third column of Table 7. It is understood that the amount of each component of the mixture as specified in Table 7 represents the average amount, and that the amount of each of the given components of the mixture may vary in the range of about ±10%, preferably of about ±5% with respect to the amounts specified in Table 7 for each component.

TABLE 7
Composition of a representative mixture containing seven structurally
distinct HMOs and two monosaccharides suitable for cereal compositions.

| | | Final concentration in |
|---|---|---|
| | | cereal composition |
| HMO | %-wt. | (g/cm³) |
| 2′-FL | 34 | 0.25 |
| 3-FL | 11 | 0.08 |
| LNT | 20 | 0.15 |
| LNnT | 2 | 0.015 |
| LNFPI | 13 | 0.10 |
| 3′-SL | 3 | 0.02 |
| 6′-SL | 4 | 0.03 |
| Sialic acid | 8 | 0.06 |
| L-fucose | 5 | 0.04 |
| Total | 100 | 0.745 |

The present invention will be described with respect to particular embodiments and with reference to the examples, but the invention is not limited thereto but only by the claims. Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, as used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification do not necessarily refer always to the same embodiment. Furthermore, the particular features, structures or characteristics may be combined in any suitable manner, as would be apparent to one of ordinary skill in the art from this disclosure, in one or more embodiments.

Similarly, it should be appreciated that in the description of representative embodiments of the invention, various features of the invention are sometimes grouped together in a single embodiment, or description thereof for the purpose of streamlining the disclosure and facilitating the understanding of one or more of the various inventive aspects. This method of disclosure is not to be interpreted as reflecting an intention that the claimed invention requires more features than are expressly listed in each claim. Rather, as the following claims reflect, inventive aspects may require fewer than all the features of any foregoing disclosed embodiment. Thus, the claims following the detailed description are hereby expressly incorporated into this detailed description, with each claim standing on its own as a separate embodiment of this invention.

Furthermore, whereas some embodiments described herein include some but not other features included in other embodiments, combinations of features of different embodiments are meant to be within the scope of the invention, and form different embodiments, as would be understood by those familiar with the art. For example, in the following claims, any of the claimed embodiments can be used in any combination.

In the description and examples provided herein, numerous specific details are set forth. However, it is understood that embodiments of the invention may be practiced without these specific details. In other instances, well-known methods, structures and techniques have not been shown in detail in order to facilitate the understanding of the description.

The invention will now be described by a detailed description of several embodiments of the invention. It is clear that other embodiments of the invention can be configured according to the knowledge of persons skilled in the art without departing from the true spirit or technical merit of the invention, the invention being limited only by the terms of the appended claims.

The following examples show only embodiments of the present invention and are not limited thereto.

### Example 1

The following cereal composition has been prepared according to one embodiment of the present invention.

100 gr of a cereal composition in the form of powder and flakes, for instant preparation, containing, based on dry weight of the cereal composition: rice flour in an amount of 18.34 wt. %, millet flour 12.34 wt. %, corn flour 17.6 wt. %, skimmed milk powder 9.20 wt. %, whole milk powder 7.35 wt. %, maltodextrin 9.96 wt. %, vitamins 1.21 wt. %, iron and zinc mix 1.51 wt. %, fat 4.12 wt. %, banana powder 8.35 wt. %, banana flavor 0.82 wt. %, and 9.2 wt. % of a mix of HMOs (the mixture of HMOs comprising five structurally distinct HMOs according to Table 5).

### Example 2

The following cereal composition has been prepared according to another embodiment of the present invention.

100 gr of a cereal composition in the form of powder and flakes, for instant preparation, containing, based on dry weight of the cereal composition: rice flour in an amount of 14.62 wt. %, corn flour 17.62 wt. %, skimmed milk powder 10.47 wt. %, yoghurt powder 7.38 wt. %, whey powder 20.60 wt. %, maltodextrin 10 wt. %, vitamins 1.21 wt. %, iron and zinc mix 1.51 wt. %, fat 5.15 wt. %, blackcurrant powder 1.54 wt. %, blueberry powder 1.24 wt. %, raspberry powder 1.55 wt. %, yoghurt flavor 0.06 wt. %, apple flakes 1.03 wt. % and 6.02 wt. % of a mix of HMOs (the mixture of HMOs comprising seven structurally distinct HMOs and 2 monosaccharides according to Table 7).

### Example 3

The following cereal composition has been prepared according to one embodiment of the present invention.

100 gr of a cereal composition in the form of powder and flakes, for instant preparation, containing, based on dry weight of the cereal composition: rice flour in an amount of 16.82 wt. %, millet flour 10.82 wt. %, corn flour 18.34 wt. %, whole milk powder 1.89 wt. %, maltodextrin 21.18 wt. %, vitamins 1.21 wt. %, iron and zinc mix 1.51 wt. %, fat 7.12 wt. %, basil flavor 0.41 wt. %, peppers flakes 2.16 wt. %, tomato powder 4.11 wt. %, potato flakes 5.15 wt. %, and 9.28 wt. % of a mix of HMOs (the mixture of HMOs comprising seven structurally distinct HMOs according to Table 6).

1. A cereal composition for instant preparation with the addition of a liquid, the cereal composition comprising one or more of the following:
from 10 to 90 wt. % of a cereal component based on dry weight of the cereal composition,
from 1 to 40 wt. % of fibre based on dry weight of the cereal composition,
from 4 to 30 wt. % of protein based on dry weight of the cereal composition,
from 1 to 10 wt. % of fat based on dry weight of the cereal composition,
from 2 to 15 wt. % of dried fruits or vegetables based on dry weight of the cereal composition,
from 1 to 10 wt. % micronutrients based on dry weight of the cereal composition,
from 0.5 to 10 wt. % of additives based on dry weight of the cereal composition,
and wherein the composition further comprises a maximum of 15 wt. %, based on dry weight of the cereal composition, of at least one human milk oligosaccharide or a mixture of human milk oligosaccharides.

2. The cereal composition according to claim 1, wherein the cereal composition further comprises from 10 to 50 wt. %, based on dry weight of the cereal composition, of a milk component.

3. The cereal composition according to claim 2, wherein the milk component is selected from one or more of the group consisting of whey powder, skimmed milk powder, whole milk powder and yoghurt powder.

4. The cereal composition according to any one of the preceding claims, wherein the cereal composition is present in a form selected from the group consisting of a powder, granules, flakes, pellets and mixtures of at least two of said forms.

5. The cereal composition according to any one of the preceding claims, wherein the liquid is selected from the group consisting of water, milk, and juice.

6. The cereal composition according to any one of the preceding claims, wherein the cereal component is present in a form selected from the group consisting of cereal flour, crushed cereal, pulverized cereal, grinned cereal and mixtures of at least two of said forms.

7. The cereal composition according to any one of the preceding claims, wherein the cereal component is selected from one or more of the group consisting of barley, oats, wheat, rice, rye, millet, sorghum and corn.

8. The cereal composition according to any one of the preceding claims, wherein the dried fruits and vegetables are present in the form of a powder or flakes.

9. The cereal composition according to any one of the preceding claims, wherein the dried fruits are selected from one or more of the group consisting of banana, raspberry, blueberry, blackcurrant, peach, apricot, apple and pear.

10. The cereal composition according to any one of the preceding claims, wherein the dried vegetables are selected from one or more of the group consisting of potato, tomato and leafy green vegetables.

11. The cereal composition according to any one of the preceding claims, wherein the micronutrients are selected from one or more of the group consisting of iron, zinc, selenium, calcium, and vitamins.

12. The cereal composition according to any one of the preceding claims, wherein the additives are selected from one or more of the group consisting of fructo-oligosaccharides (FOS), galacto-oligosaccharides (GOS), maltodextrin, colorants and sweeteners.

13. The cereal composition according to any one of the preceding claims, wherein the at least one human milk oligosaccharide is selected the group consisting of acetyl-N-lactosamine, sialylated oligosaccharide, and fucosylated oligosaccharides.

14. The cereal composition according to claim 13, wherein the acetyl-N-lactosamine is selected from one or more of the group consisting of lacto-N-tetraose (LNT), lacto-N-neotetraose (LNnT) and lacto-N-fucopentaose I (LNPFI).

15. The cereal composition according to claim 13, wherein the sialylated oligosaccharide is selected from one or more of the group consisting of 3′-sialyllactose (3′-SL), 6′-sialyllactose (6′-SL), sialyllacto-N-tetraose a (LST-a), sialyllacto-N-tetraose b (LST-b), sialyllacto-N-tetraose c (LST-c) and disialyllacto-N-tetraose (DSLNT).

16. The cereal composition according to claim 13, wherein the fucosylated oligosaccharide is selected from one or more of the group consisting of 2′-fucosyllactose (2′-FL) and 3-fucosyllactose (3-FL).

17. The cereal composition according to any one of the preceding claims, wherein the mixture of human milk oligosaccharides contains at least five structurally distinct HMOs, preferably selected from the group consisting of 2′-fucosyllactose (2′-FL), 3-fucosyllactose (3-FL), lacto-N-tetraose (LNT), 3′-sialyllactose (3′-SL) and 6′-sialyllactose (6′-SL).

18. The cereal composition according to any one of the preceding claims, wherein the mixture of human milk oligosaccharides contains at least seven structurally distinct HMOs, preferably selected from the group consisting of 2′-fucosyllactose (2′-FL), 3-fucosyllactose (3-FL), lacto-N-tetraose (LNT), lacto-N-neotetraose (LNnT), lacto-N-fucopentaose I (LNFPI), 3′-sialyllactose (3′-SL) and 6′-sialyllactose (6′-SL).

19. The cereal composition according to any one of the preceding claims, wherein the cereal composition further contains at least one monosaccharide, said at least one monosaccharide being preferably selected from the group consisting of L-fucose and sialic acid.
